(19) United States
(12) Patent Application Publication
(10) Pub. No.: US 2026/0195640 A1
(43) Pub. Date: Jul. 9, 2026

(54) ENHANCING LONG-CONTEXT REASONING CAPABILITIES OF MACHINE LEARNING MODELS

(71) Applicant: Bytedance Technology Ltd., Grand Cayman (KY)

(72) Inventors: Zhan Ling, Los Angeles, CA (US); Kang Liu, Los Angeles, CA (US); Jiecao Chen, Los Angeles, CA (US)

(21) Appl. No.: 19/012,699

(22) Filed: Jan. 7, 2025

(51) Int. Cl. G06N 20/00

(52) U.S. Cl. CPC G06N 20/00

(57) ABSTRACT

Each short reasoning data item can be automatically decomposed into a background and an inquiry on the background. A plurality of materials can be automatically generated based on the background. Each of the plurality of materials can indicate a key information point of the background. A long-context background can be automatically constructed by randomly embedding the plurality of materials into a set of irrelevant materials. A plurality of long reasoning data items can be automatically generated by combining the long-context background with the inquiry corresponding to each short reasoning data item.

### BACKGROUND

Machine learning models have demonstrated capabilities of understanding and responding to short context queries. However, the machine learning models can struggle with tasks requiring long-context reasoning. As such, techniques for enhancing the long-context reasoning capabilities of machine learning models are needed.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for automatically generating long-context reasoning data in accordance with the present disclosure.

FIG. 2 shows an example process for automatically generating long-context reasoning data in accordance with the present disclosure.

FIG. 3 shows an example process for automatically generating long-context reasoning data in accordance with the present disclosure.

FIG. 4 shows example data pairs in accordance with the present disclosure.

FIG. 5 shows example system for generating an answer to a long-context question using a machine learning model in accordance with the present disclosure.

FIG. 6 shows an example process for automatically generating long-context reasoning data in accordance with the present disclosure.

FIG. 7 shows an example process for training a machine learning model in accordance with the present disclosure.

FIG. 8 shows an example process for enhancing long-context reasoning capabilities of a machine learning model in accordance with the present disclosure.

FIG. 9 shows an example process for generating short reasoning data items in accordance with the present disclosure.

FIG. 10 shows an example graph illustrating a quantity of reasoning steps in short reasoning data items in accordance with the present disclosure.

FIG. 11 shows an example process for verifying whether a background and inquiry generated from a decomposition retains a meaning of a corresponding short-reasoning data item in accordance with the present disclosure.

FIG. 12 shows an example process for verifying whether a plurality of independent passages and an inquiry retains a meaning of a corresponding short-reasoning data item in accordance with the present disclosure.

FIG. 13 shows an example computing device which may be used to perform any of the techniques disclosed herein.

### DETAILED DESCRIPTION OF ILLUSTRATIVE EMBODIMENTS

The ability of machine learning models to comprehend and reason over long inputs is essential for applications, such as multi-turn conversations, document understanding, retrieval-augmented generation, and language agents. However, it can be difficult to obtain enough data to train machine learning models to comprehend and reason over long inputs, as publicly available long-context question-answer data is scarce. Also, creating realistic long-context tasks from extensive texts is both challenging and time-consuming. This limitation restricts the expansion of datasets to accommodate arbitrary context lengths and the ability to support controllable context. Further, existing datasets often utilize documents from specific domains, such as financial reports or legal cases, as input, which can inherently limit the diversity of task categories. Consequently, they tend to focus on a narrow set of tasks, such as comparison or classification, rather than evaluating more complex and challenging tasks that require chain-of-thought reasoning.

To address these challenges, described herein are techniques for evaluating and enhancing long-context reasoning capabilities of machine learning models. A new synthetic long-context reasoning benchmark (hereinafter referred to as “LongReason”), which can be used to assess and enhance the long-context reasoning abilities of machine learning models, is described herein. The new synthetic long-context reasoning benchmark described herein encompasses a diverse range of task categories and supports controllable context lengths. Long-context reasoning questions can be synthesized from existing short questions, reducing the need for labor-intensive human annotation for long-context data.

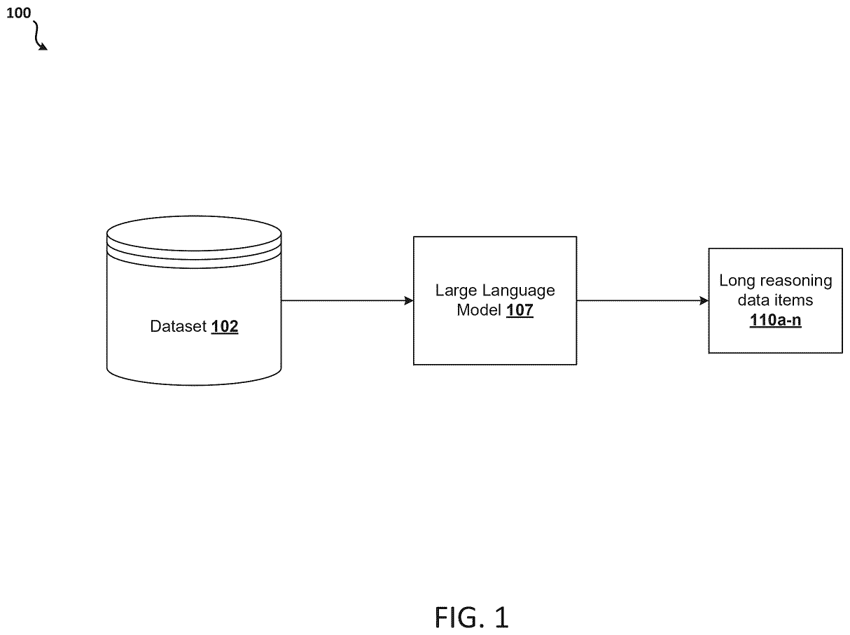

FIG. 1 shows an example system 100 for automatically generating long-context reasoning data. The system 100 can comprise a dataset 102 and a large language model 107. The database 102 can include short questions with diverse patterns from different task categories. For example, the short questions can include reasoning questions with diverse patterns from three major task categories: reading comprehension, logical inference, and mathematical word problems. The short questions can include multiple-choice questions. Each of the short questions can be associated with a known answer (e.g., a ground-truth answer).

The large language model 107 can receive (e.g., retrieve) the short questions from the dataset 102. For example, the short questions from the dataset 102 are input into the large language model 107. The large language model 107 can refine the short questions to remove any data contamination from the short questions. The large language model 107 can be prompted to evaluate each of the refined short questions to determine the quantity of reasoning steps in its corresponding ground-truth reasoning chain. The large language model 107 can be prompted to determine a subset of the refined short questions that satisfies a threshold quantity (e.g., two steps, three steps, etc.) of reasoning steps to arrive at a final answer. The subset of the refined short questions, which can herein be referred to as “the plurality of short reasoning data items,” can be used to generate a plurality of long reasoning data items.

The large language model 107 can be prompted to decompose each of the plurality of short reasoning data items into a background (e.g., original background) and an inquiry (e.g., original inquiry) on the background. To decompose each of the plurality of short reasoning data items into a background and an inquiry on the background, the large language model 107 can extract key elements (e.g., keywords, time, main characters, event names, etc.) from each of the plurality of short reasoning data items. Based on extracting the key elements from each of the plurality of short reasoning data items, the large language model 107 can incorporate the key elements into both the background and the inquiry corresponding to each short reasoning data item to ensure that the inquiry is linked to the background.

After decomposing each of the plurality of short reasoning data items into a background and an inquiry on the background, the large language model 107 can generate a plurality of materials based on each background. That is, for each background, the large language model 107 can generate a plurality of materials. Each of the plurality of materials can indicates a key information point of the corresponding background. The plurality of materials can include a plurality of independent and complete passages, with each of the plurality of independent and complete passages corresponding to one of a plurality of key information points of the background. Ensuring that the plurality of materials retain certain keywords similar to those used during the decomposition stage ensures that all passages are closely related to the final inquiry.

The large language model 107 can be prompted to construct a long-context background corresponding to each of the backgrounds decomposed from each of short reasoning data items. To construct a long-context background corresponding to a particular background, the large language model 107 can randomly embed the plurality of materials corresponding to the particular background into a set of irrelevant materials. For example, the large language model 107 can construct the long-context background by embedding each of the plurality of materials at a random position within the set of irrelevant materials. The set of irrelevant materials can include textual material that is not relevant to a corresponding short reasoning data item. The large language model 107 can generate a plurality of long reasoning data items 110a-n by combining each long-context background with the corresponding inquiry. For example, the large language model 107 can generate a long reasoning data item corresponding to each of the plurality of short reasoning data items, where the long reasoning data item corresponding to a particular short reasoning data item includes the long-context background (instead of the original background) and the original inquiry.

In embodiments, a machine learning model (e.g., a large language model) can be trained to perform long-context reasoning tasks based on a plurality of long reasoning data items. For example, the machine learning model can be trained based on the plurality of long reasoning data items and the corresponding ground-truth answers. After the machine learning model is trained, the machine learning model can receive, comprehend and reason over a long-context question and generate an answer to the long-context question.

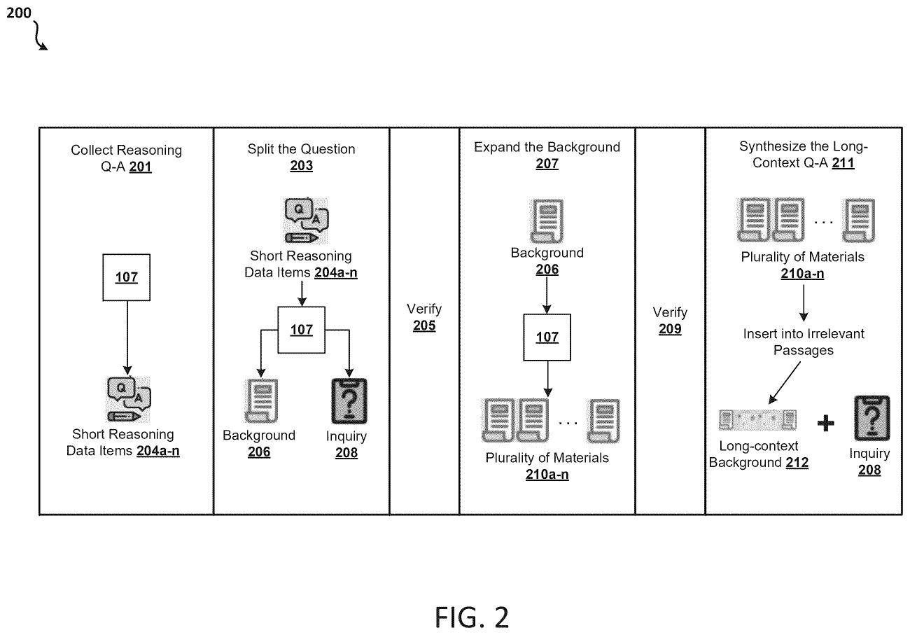

FIG. 2 shows an example process 200 for automatically generating long-context reasoning data. The process 200 can be performed to generate the plurality of long reasoning data items 110a-n. For example, the process 200 can be performed to synthesize multi-hop long-context reasoning questions (e.g., up to 128K tokens) from collected short-context problems. To ensure quality, a large language model (e.g., large language model 107) can be leveraged to automatically verify the generated questions, ensuring they retain the same logic as their shorter counterparts. This synthetic pipeline supports converting one short reasoning question into different lengths, enabling fine-grained assessment and enhancement of long-context reasoning capabilities of machine learning models across various context lengths and reasoning tasks.

At 201, short reasoning question-answer pairs can be collected. The short reasoning question-answer pairs can include short questions with diverse patterns from different task categories. For example, the short reasoning question-answer pairs can include reasoning questions with diverse patterns from three major task categories: reading comprehension, logical inference, and mathematical word problems. The short reasoning question-answer pairs can include multiple-choice questions. Each of the short reasoning question-answer pairs can be associated with a known answer (e.g., a ground-truth answer).

The large language model 107 can generate a plurality of short reasoning data items 204a-n based on the short reasoning question-answer pairs. To generate the plurality of short reasoning data items 204a-n, the large language model 107 can refine the short reasoning question-answer pairs to remove any data contamination. The large language model 107 can evaluate each of the refined short reasoning question-answer pairs to determine the quantity of reasoning steps in its corresponding ground-truth reasoning chain. The large language model 107 can select a subset of the refined short reasoning question-answer pairs that satisfies a threshold quantity (e.g., two steps, three steps, etc.) of reasoning steps as the plurality of short reasoning data items 204a-n.

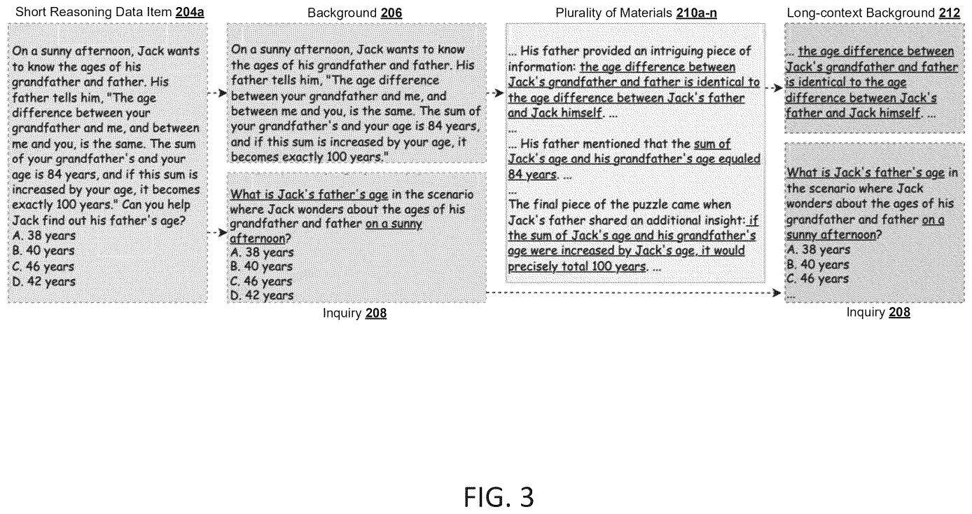

At 203, each of the plurality of short reasoning data items 204a-n can be split (e.g., decomposed). The large language model 107 can be prompted to decompose each of the plurality of short reasoning data items 204a-n into a background 206 and an inquiry 208 in a chain-of-thought manner. The inquiry 208 can include a question about the background 206. As shown in the example of FIG. 3, the large language model 107 can decompose the short reasoning data item 204a into a background 206 and an inquiry 208 (e.g., What is Jack's father's age?). The background 206 can include the background context that is needed to answer the inquiry 208.

Referring back to FIG. 2, at 205, the large language model 107 can be prompted to verify whether the background 206 and the inquiry 208 generated from each decomposition retains a meaning of a corresponding short reasoning data item 204a-n. If the large language model 107 determines that the background 206 or the inquiry 208 generated from a particular decomposition does not retain a meaning of a corresponding short reasoning data item 204a-n, the process 200 can return to 201, where a short reasoning data item can be resampled. Conversely, if the large language model 107 determines that the background 206 and the inquiry 208 generated from a decomposition retains a meaning of a corresponding short reasoning data item 204a-n, the process 200 can proceed to 207. Only the background and the inquiry generated from a decomposition that successfully passes the self-verification process conducted by the large language model can be retained.

At 207, each background 206 can be expanded. To expand each background 206, the large language model 107 can generate a plurality of materials 210a-n based on each background 206. That is, for each background 206, the large language model 107 can generate a plurality of materials 210a-n. Each of the plurality of materials 210a-n can indicate a key information point of the corresponding background 206. As shown in the example of FIG. 3, the plurality of materials 210a-n can include a plurality of independent and complete passages (e.g., paragraphs), with each of the plurality of independent and complete passages corresponding to one key information point of the background 206. The

Referring back to FIG. 2, at 209, the large language model 107 can be prompted to verify whether the plurality of materials 210a-n (e.g., the plurality of independent and complete passages) and/or the inquiry 208 retains a same meaning as a corresponding short reasoning data item. This self-verification stage can ensure the quality of the expanded context. If the large language model 107 determines that a plurality of independent and complete passages and/or the inquiry does not retain a meaning of a corresponding short reasoning data item 204a-n, the process 200 can return to 201, where a short reasoning data item can be resampled. Conversely, if the large language model 107 determines that the plurality of independent and complete passages and the inquiry 208 retains a same meaning as a corresponding short reasoning data item, the process 200 can proceed to 211. Only the materials expanded from 207 that successfully pass the self-verification process can be retained.

At 211, a plurality of long reasoning data items 110a-n can be synthesized. A long reasoning data item corresponding to each short reasoning data item can be generated. To synthesize the long reasoning data item corresponding to a particular short reasoning data item, the large language model 107 can randomly insert the corresponding plurality of independent and complete passages into a set of irrelevant materials to generate a long-context background 212. The set of irrelevant materials can include textual material that is not relevant to the particular short reasoning data item. As such, the long-context background 212 can include multiple paragraphs from diverse sources, while only a small subset of the information in the long-context background 212 is directly relevant to answering the inquiry 108. The large language model 107 can rewrite each of the plurality of independent and complete passages to minimize stylistic differences between the synthesized background passages and the irrelevant passages. The large language model 107 can combine (e.g., merge) the long-context background 212 with the inquiry 208 to generate the plurality of long reasoning data items 110a-n.

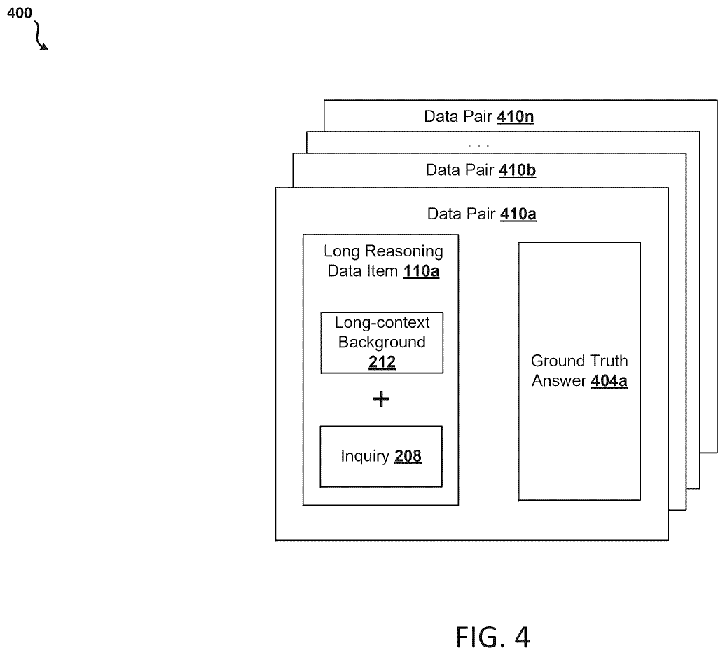

The long reasoning data items can be used to construct a dataset. FIG. 4 shows a dataset 400 constructed based on the long reasoning data items and corresponding ground truth answers. The dataset 400 can include a plurality of data pairs 410a-n. Each of the plurality of data pairs 410a-n can include one of the plurality of long reasoning data items 110a-n. As shown in FIG. 4, the data pair 410a can include the long reasoning data item 110a and a ground-truth answer 404a corresponding to the long reasoning data item 110a. The long reasoning data item 110a can include a long-context background 212 and an inquiry 208. Similarly, the data pair 410b can include the long reasoning data item 110b and a ground-truth answer 404b corresponding to the long reasoning data item 110b, the data pair 410c can include the long reasoning data item 110c and a ground-truth answer 404c corresponding to the long reasoning data item 110c, etc.

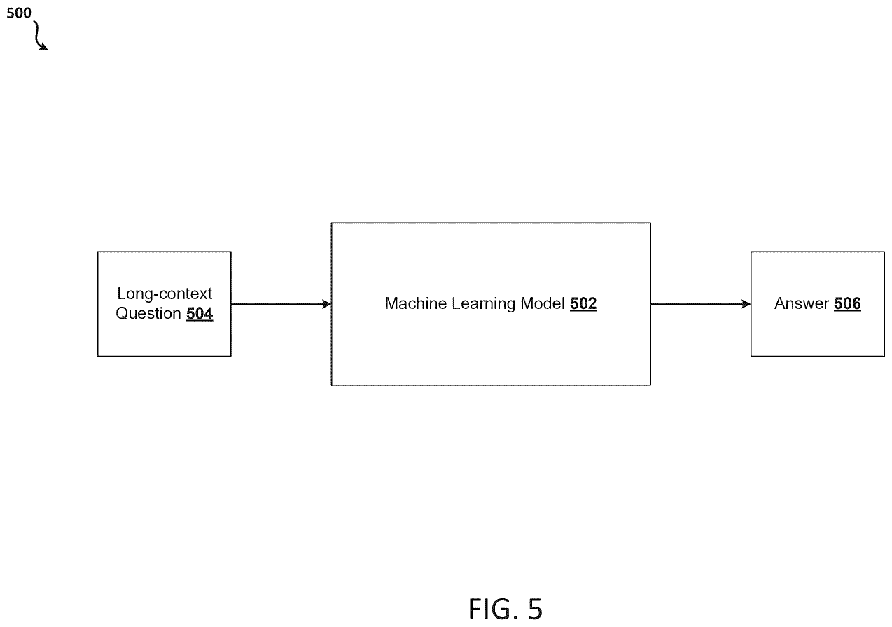

A machine learning model can be trained to perform long-context reasoning tasks based on the dataset 400. The machine learning model can include the large language model 107, or a different machine learning model (e.g., a different large language model). By training the machine learning model, the machine learning model can comprehend and reason over a long-context question and generate an answer to the long-context question. FIG. 5 shows an example for training a machine learning model 502 based on the dataset 400. After training the machine learning model 502 on the dataset 400, the machine learning model 502 can comprehend and reason over a long-context question 504 and generate an answer 506 to the long-context question.

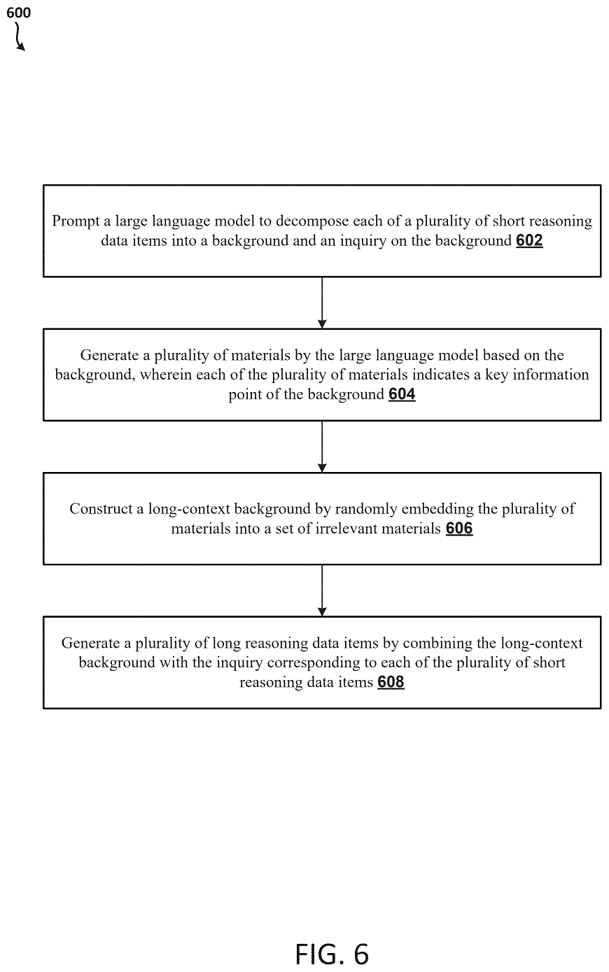

FIG. 6 shows an example process 600 for automatically generating long-context reasoning data items. Although depicted as a sequence of operations in FIG. 6, those of ordinary skill in the art will appreciate that various embodiments may add, remove, reorder, or modify the depicted operations.

At 602, a large language model (e.g., large language model 107) can be prompted. The large language model can be prompted to automatically decompose each of a plurality of short reasoning data items (e.g., plurality of short reasoning data items 204a-n) into a background (e.g., original background 206) and an inquiry (e.g., inquiry 208) on the background. At 604, a plurality of materials (e.g., plurality of materials 210a-n) can be automatically generated. The plurality of materials can be generated by the large language model. The plurality of materials can be generated based on the background. Each of the plurality of materials can indicate a key information point of the background. That is, for each background decomposed from each short reasoning data item, the large language model can automatically generate a plurality of materials.

At 606, a long-context background (e.g., long-context background 212) can be generated. A long-context background corresponding to each original background can be generated. The long-context background corresponding to a particular background decomposed from a particular short reasoning data item can be generated by randomly embedding the corresponding plurality of materials into a set of irrelevant materials. Each long-context background can include multiple paragraphs, while only a small subset of the information in the long-context background is directly relevant to answering the corresponding inquiry. At 608, a plurality of long reasoning data items (e.g., plurality of long reasoning data items 110a-n) can be automatically generated. Each of the plurality of long reasoning data items can correspond to one of the plurality of short reasoning data items. Each of the plurality of long reasoning data items can be generated by combining the long-context background with the corresponding inquiry.

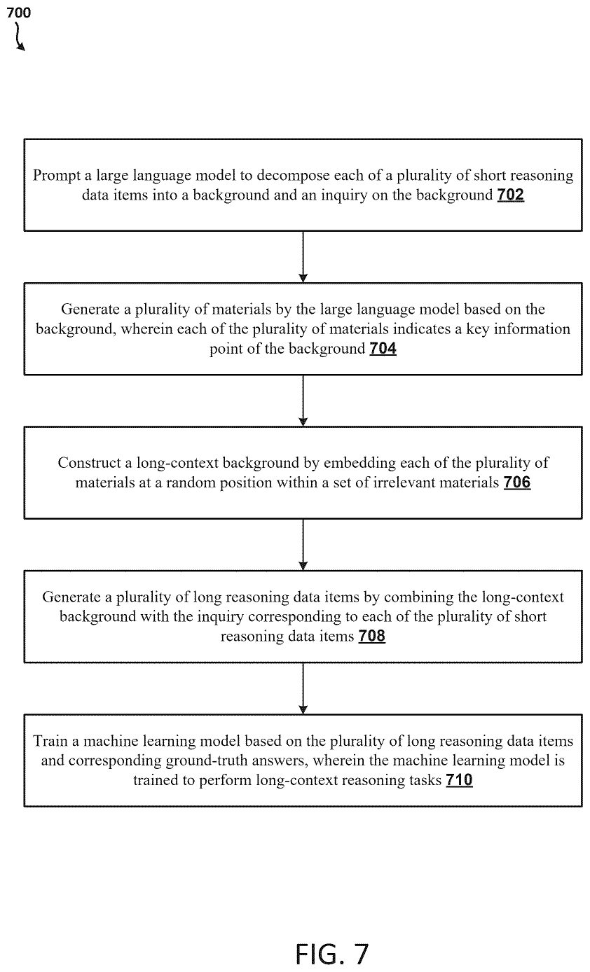

FIG. 7 shows an example process 700 for training a machine learning model. Although depicted as a sequence of operations in FIG. 7, those of ordinary skill in the art will appreciate that various embodiments may add, remove, reorder, or modify the depicted operations.

At 702, a large language model (e.g., large language model 107) can be prompted. The large language model can be prompted to automatically decompose each of a plurality of short reasoning data items (e.g., plurality of short reasoning data items 204a-n) into a background (e.g., original background 206) and an inquiry (e.g., inquiry 208) on the background. At 704, a plurality of materials (e.g., plurality of materials 210a-n) can be generated. The plurality of materials can be automatically generated by the large language model. The plurality of materials can be generated based on the background. Each of the plurality of materials can indicate a key information point of the background. That is, the large language model can generate a plurality of materials for each background decomposed from each short reasoning data item.

At 706, a long-context background (e.g., long-context background 212) can be generated. A long-context background corresponding to each background decomposed from each short reasoning data item can be automatically generated. The long-context background corresponding to a particular background can be generated by randomly embedding the corresponding plurality of materials into a set of irrelevant materials. Each long-context background can include multiple paragraphs from diverse sources, while only a small subset of the information in the long-context background is directly relevant to answering the corresponding inquiry. At 708, a plurality of long reasoning data items (e.g., plurality of long reasoning data items 110a-n) can be automatically generated. Each of the plurality of long reasoning data items can correspond to one of the plurality of short reasoning data items. Each of the plurality of long reasoning data items can be generated by combining each long-context background with a corresponding inquiry. At 710, a machine learning model (e.g., machine learning model 502) can be trained. The machine learning model can be trained based on the plurality of long reasoning data items and corresponding ground-truth answers. The machine learning model can be trained to perform long-context reasoning tasks. The trained machine learning model has an enhanced long-context reasoning capability.

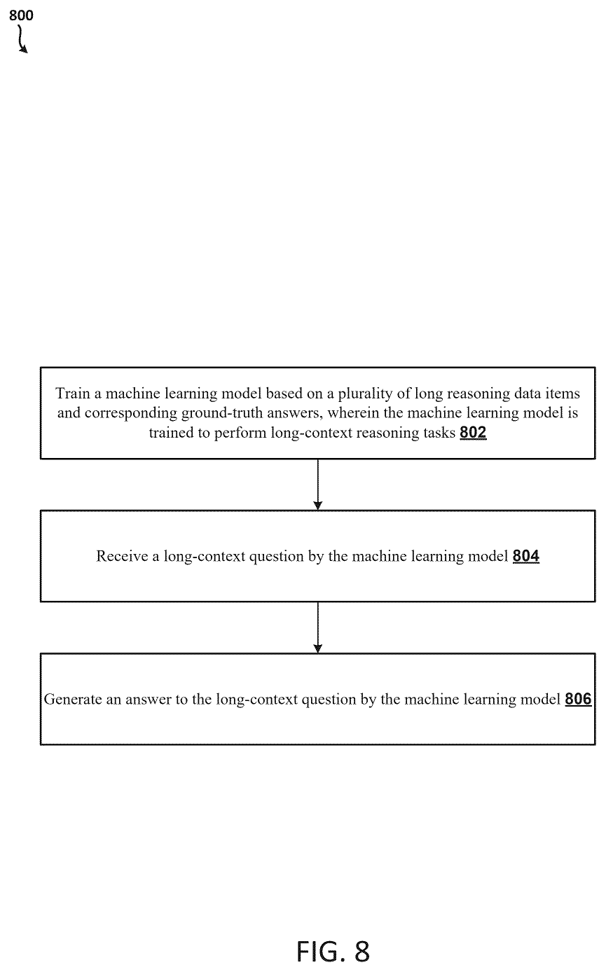

FIG. 8 shows an example process 800 for implementing a machine learning model with an enhanced long-context reasoning capability. Although depicted as a sequence of operations in FIG. 8, those of ordinary skill in the art will appreciate that various embodiments may add, remove, reorder, or modify the depicted operations.

A plurality of long reasoning data items (e.g., plurality of long reasoning data items 110a-n) can be automatically generated. Each of the plurality of long reasoning data items can be generated by combining a long-context background with a corresponding inquiry. At 802, a machine learning model (e.g., machine learning model 502) can be trained. The machine learning model can be trained based on the plurality of long reasoning data items and corresponding ground-truth answers. The machine learning model can be trained to perform long-context reasoning tasks. At 804, a long-context question (e.g., long-context question 504) can be received by (e.g., input into) the machine learning model. The long-context question can have a length of up to 128K tokens. At 806, an answer (e.g., answer 506) can be generated by the machine learning model. The answer can include an answer to the long-context question.

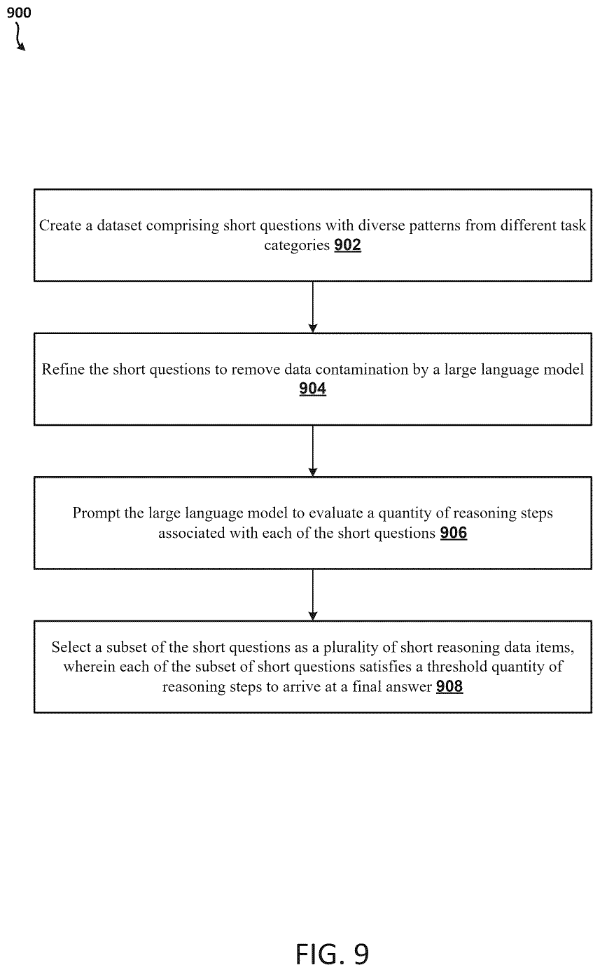

FIG. 9 shows an example process 900 for generating a plurality of short reasoning data items. Although depicted as a sequence of operations in FIG. 9, those of ordinary skill in the art will appreciate that various embodiments may add, remove, reorder, or modify the depicted operations.

At 902, a dataset (e.g., dataset 102) can be created. The dataset can include short questions with diverse patterns from different task categories. For example, the dataset can include short questions with diverse patterns from three major task categories: reading comprehension, logical inference, and mathematical word problems. The short questions can include multiple-choice questions. Each of the short questions can be associated with a known answer (e.g., a ground-truth answer). At 904, the short questions can be refined. The short questions can be refined by a large language model (e.g., large language model 107) to remove data contamination from the short questions.

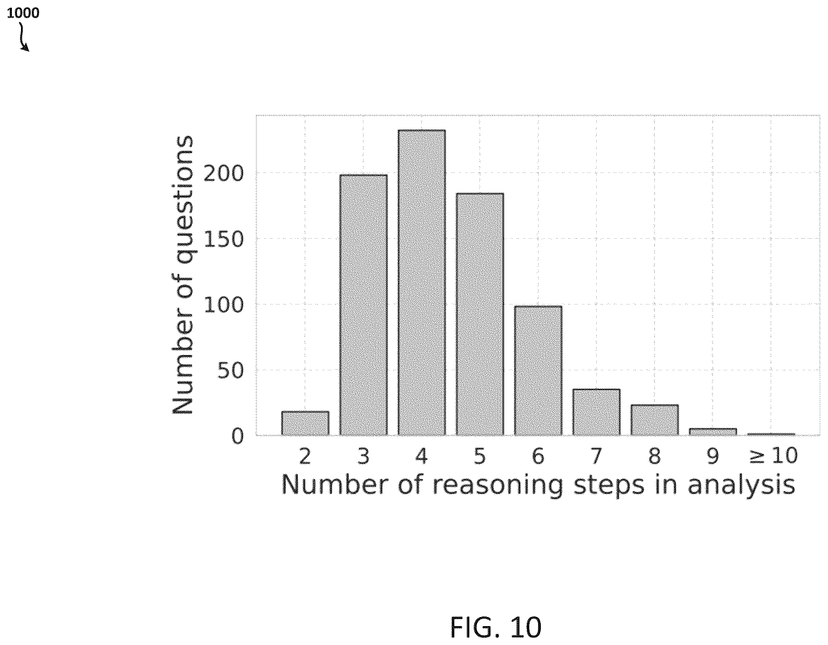

At 906, the large language model can be prompted. The large language model can be prompted to evaluate a quantity of reasoning steps associated with each of the short questions. The large language model can evaluate each of the refined short reasoning question-answer pairs to determine a quantity of reasoning steps in its corresponding ground-truth reasoning chain. At 908, a subset of the short questions can be selected as a plurality of short reasoning data items. Each of the subset of short questions can satisfy a threshold quantity of reasoning steps (e.g., two, three, etc.) to arrive at a final answer. As shown in the example graph 1000 of FIG. 10, the subset of short questions can include questions that have a quantity of reasoning steps ranging from two reasoning steps to ten+ reasoning steps, with the greatest quantity of questions in the subset of short questions having four reasoning steps.

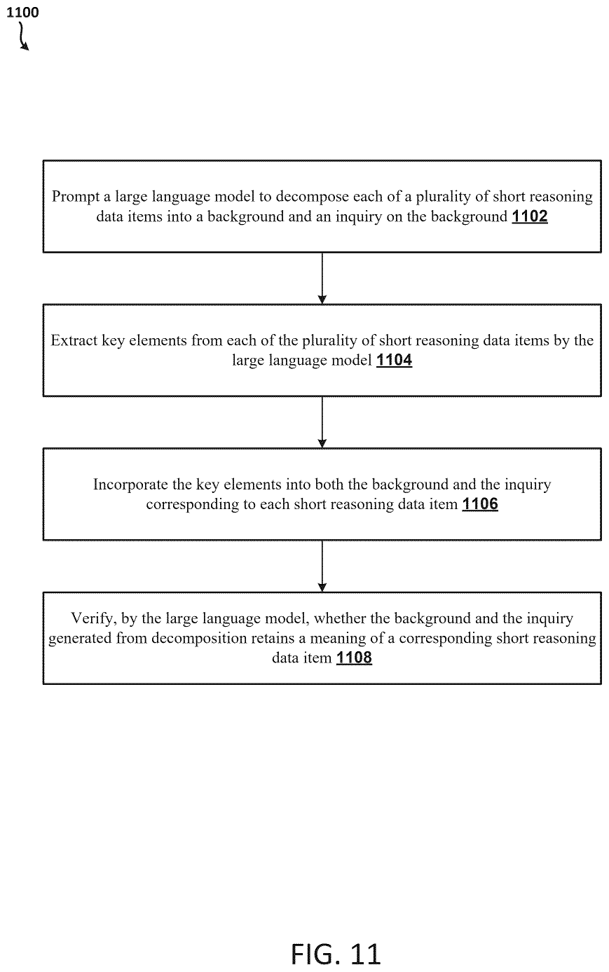

FIG. 11 shows an example process 1100 for verifying whether a background and inquiry generated from a decomposition retains a meaning of a corresponding short-reasoning data item. Although depicted as a sequence of operations in FIG. 11, those of ordinary skill in the art will appreciate that various embodiments may add, remove, reorder, or modify the depicted operations.

At 1102, a large language model (e.g., large language model 107) can be prompted. The large language model can be prompted to decompose each of a plurality of short reasoning data items (e.g., plurality of short reasoning data items 204a-n) into a background (e.g., original background 206) and an inquiry (e.g., inquiry 208) on the background. At 1104, key elements (e.g., keywords, time, main characters, event names, etc.) can be extracted from each of the plurality of short reasoning data items. The key elements can be extracted by the large language model. At 1106, each of a plurality of short reasoning data items can be automatically decomposed into the background and the inquiry based on incorporating the key elements into both the background and the inquiry corresponding to each short reasoning data item. At 1108, the large language model can automatically verify whether the background and the inquiry generated from decomposition retains a meaning of a corresponding short reasoning data item. For example, the large language model can be prompted to verify whether the background and the inquiry generated from decomposition retains a meaning of a corresponding short reasoning data item.

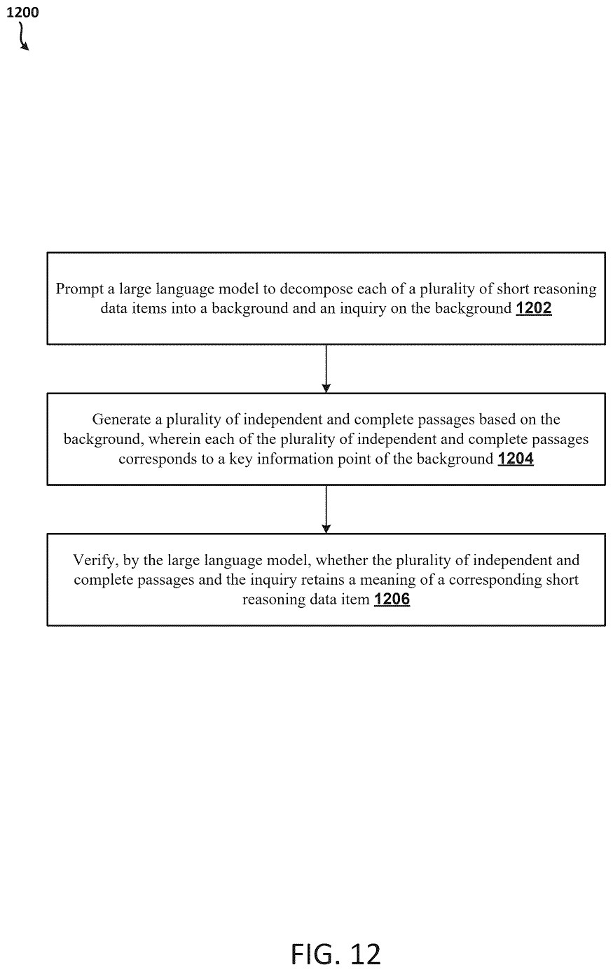

FIG. 12 shows an example process 1200 for verifying whether a plurality of independent passages and an inquiry retains a meaning of a corresponding short-reasoning data item. Although depicted as a sequence of operations in FIG. 12, those of ordinary skill in the art will appreciate that various embodiments may add, remove, reorder, or modify the depicted operations.

At 1202, a large language model (e.g., large language model 107) can be prompted. The large language model can be prompted to decompose each of a plurality of short reasoning data items (e.g., plurality of short reasoning data items 204a-n) into a background (e.g., original background 206) and an inquiry (e.g., inquiry 208) on the background. At 1204, a plurality of independent and complete passages (e.g., paragraphs) can be generated. The plurality of independent and complete passages can be generated based on the background. Each of the plurality of independent and complete passages corresponds to a key information point of the background. At 1206, the large language model can automatically verify whether the plurality of independent and complete passages and the inquiry retains a meaning of a corresponding short reasoning data item. For example, the large language model can be prompted to verify whether the plurality of independent and complete passages and the inquiry retains a meaning of a corresponding short reasoning data item.

A comprehensive set of experiments was conducted to compare the dataset described herein (e.g., LongReason) with other long-context benchmarks. As compared to other long-context benchmarks, LongReason offers controllable context lengths and incorporating diverse and realistic tasks without the need for human annotation on long text.

Further, a set of experiments was conducted to evaluate a broad set of large language models using the dataset described herein (e.g., LongReason). A set of representative large language models that support long context windows, including 6 closed-source models from 3 model families and 15 opensource models spanning a wide range of model sizes (3B to 123B) and claimed context lengths (8K to 2M) were selected. All selected models were evaluated on LongReason, which, in one embodiment, comprises 794 questions, each featuring multiple variations, including the original version, expanded versions, and long-context versions with context lengths of 8K, 16K, 32K, 64K, and 128K. Each input was constructed using a predefined zero-shot chain-of-thought template that combines the background context, followed by the corresponding final inquiry. To assess the reasoning performance of the large language models, the predicted choice was extracted by identifying the first character sequence following the phrase “the answer is” and was compared to the ground-truth option for accuracy.

A significant performance drop occurred across nearly all models when evaluated on Qexpanded compared to Qshort. To ensure this decline is not caused by the quality of the synthetic questions, twenty failure cases, where correct answers on Qshort turn incorrect on Qexpanded, were examined. Only three cases involve ambiguity or errors introduced by context expansion. Similarly, when comparing Qexpanded to Q8K, a large performance drop persisted. Among twenty failure cases where correct answers on Q8K turn incorrect on Qexpanded, only two cases were affected by added irrelevant information. The long-context reasoning capabilities of open-source large language models lag behind those of the most advanced closed-source models in LongReason. For example, the best-performing open-source model experiences a significant performance drop (5.05%) when the input context length increases from 64K to 128K. Furthermore, a comparison of a model of different sizes reveals that performance declines at a similar rate across all model sizes as context length increases. Smaller models perform worse overall, primarily due to their weaker reasoning abilities, even in shorter-context scenarios.

Further analysis was conducted on LongReason to provide a deeper understanding of the long-context reasoning performance of existing large language models. This analysis showed that the performance of state-of-the-art language models is highly sensitive to the position of the final inquiry. Although some closed-source models demonstrate excellent long-context reasoning performance when the final inquiry is placed after the background context, they still struggle when the inquiry is positioned at the beginning of the input, before the background context. Meanwhile, other closed-source models demonstrate similar performance in both cases, particularly when the context length is short. However, as the input length increases, the performance of such closed source models still declines significantly for questions with the final inquiry is placed before the background context. This analysis further showed that large language models do not have similar long-context reasoning performance over different tasks and clue placement in LongReason. Multiple closed-source models demonstrated strong long-context reasoning performance on reading comprehension problems. However, for logic and math problems, some closed-source models significantly underperform compared to other closed-source models. Further, it was observed that for these problem types, some closed-source models show much lower performance when the clues are distributed separately throughout the context, compared to when the clues are grouped together.

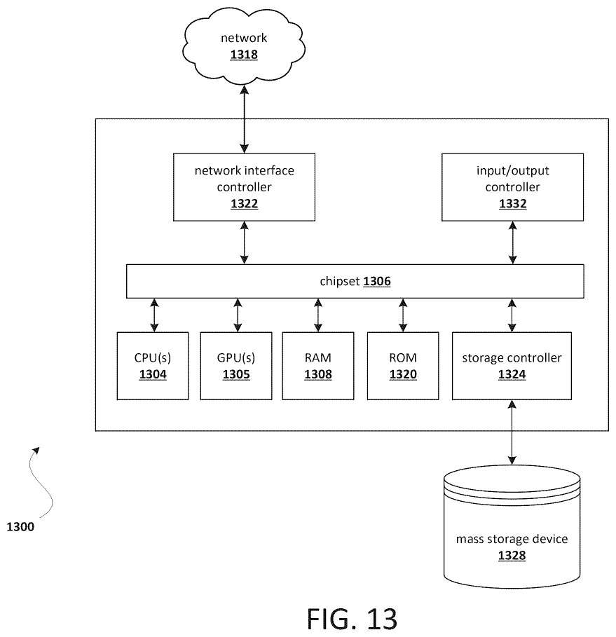

FIG. 13 illustrates a computing device that may be used in various aspects, such as the model(s), components, and/or devices depicted in FIGS. 1-5. With regard to FIGS. 1-5, any or all of the components may each be implemented by one or more instance of a computing device 1300 of FIG. 13. The computer architecture shown in FIG. 13 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1300 may include a baseboard, or “motherboard,” which is a printed circuit board to which a multitude of components or devices may be connected by way of a system bus or other electrical communication paths. One or more central processing units (CPUs) 1304 may operate in conjunction with a chipset 1306. The CPU(s) 1304 may be standard programmable processors that perform arithmetic and logical operations necessary for the operation of the computing device 1300.

The CPU(s) 1304 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1304 may be augmented with or replaced by other processing units, such as GPU(s) 1305. The GPU(s) 1305 may comprise processing units specialized for but not necessarily limited to highly parallel computations, such as graphics and other visualization-related processing.

A chipset 1306 may provide an interface between the CPU(s) 1304 and the remainder of the components and devices on the baseboard. The chipset 1306 may provide an interface to a random-access memory (RAM) 1308 used as the main memory in the computing device 1300. The chipset 1306 may further provide an interface to a computer-readable storage medium, such as a read-only memory (ROM) 1320 or non-volatile RAM (NVRAM) (not shown), for storing basic routines that may help to start up the computing device 1300 and to transfer information between the various components and devices. ROM 1320 or NVRAM may also store other software components necessary for the operation of the computing device 1300 in accordance with the aspects described herein.

The computing device 1300 may operate in a networked environment using logical connections to remote computing nodes and computer systems through local area network (LAN). The chipset 1306 may include functionality for providing network connectivity through a network interface controller (NIC) 1322, such as a gigabit Ethernet adapter. A NIC 1322 may be capable of connecting the computing device 1300 to other computing nodes over a network 1318. It should be appreciated that multiple NICs 1322 may be present in the computing device 1300, connecting the computing device to other types of networks and remote computer systems.

The computing device 1300 may be connected to a mass storage device 1328 that provides non-volatile storage for the computer. The mass storage device 1328 may store system programs, application programs, other program modules, and data, which have been described in greater detail herein. The mass storage device 1328 may be connected to the computing device 1300 through a storage controller 1324 connected to the chipset 1306. The mass storage device 1328 may consist of one or more physical storage units. The mass storage device 1328 may comprise a management component 1310. A storage controller 1324 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1300 may store data on the mass storage device 1328 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1328 is characterized as primary or secondary storage and the like.

For example, the computing device 1300 may store information to the mass storage device 1328 by issuing instructions through a storage controller 1324 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1300 may further read information from the mass storage device 1328 by detecting the physical states or characteristics of one or more particular locations within the physical storage units.

In addition to the mass storage device 1328 described above, the computing device 1300 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1300.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1328 depicted in FIG. 13, may store an operating system utilized to control the operation of the computing device 1300. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 13228 may store other system or application programs and data utilized by the computing device 1300.

The mass storage device 1328 or other computer-readable storage media may also be encoded with computer-executable instructions, which, when loaded into the computing device 1300, transforms the computing device from a general-purpose computing system into a special-purpose computer capable of implementing the aspects described herein. These computer-executable instructions transform the computing device 1300 by specifying how the CPU(s) 1304 transition between states, as described above. The computing device 1300 may have access to computer-readable storage media storing computer-executable instructions, which, when executed by the computing device 1300, may perform the methods described herein.

A computing device, such as the computing device 1300 depicted in FIG. 13, may also include an input/output controller 1332 for receiving and processing input from a number of input devices, such as a keyboard, a mouse, a touchpad, a touch screen, an electronic stylus, or other type of input device. Similarly, an input/output controller 1332 may provide output to a display, such as a computer monitor, a flat-panel display, a digital projector, a printer, a plotter, or other type of output device. It will be appreciated that the computing device 1300 may not include all of the components shown in FIG. 13, may include other components that are not explicitly shown in FIG. 13, or may utilize an architecture completely different than that shown in FIG. 13.

As described herein, a computing device may be a physical computing device, such as the computing device 1300 of FIG. 13. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of enhancing long-context reasoning capabilities of machine learning models, comprising:
prompting a large language model to decompose each of a plurality of short reasoning data items into a background and an inquiry on the background;
generating a plurality of materials by the large language model based on the background, wherein each of the plurality of materials indicates a key information point of the background;
constructing a long-context background by embedding the plurality of materials into a set of irrelevant materials; and
generating a plurality of long reasoning data items by combining the long-context background with the inquiry corresponding to each of the plurality of short reasoning data items.

2. The method of claim 1, further comprising:
training a machine learning model based on the plurality of long reasoning data items and corresponding ground-truth answers, wherein the machine learning model is trained to perform long-context reasoning tasks.

3. The method of claim 2, further comprising:
receiving a long-context question by the machine learning model; and
generating an answer to the long-context question by the machine learning model.

4. The method of claim 1, further comprising:
creating a dataset comprising short questions with diverse patterns from different task categories;
refining the short questions to remove data contamination by the large language model.

5. The method of claim 4, further comprising:
prompting the large language model to evaluate a quantity of reasoning steps associated with each of the short questions; and
selecting a subset of the short questions as the plurality of short reasoning data items, wherein each of the subset of short questions satisfies a threshold quantity of reasoning steps to arrive at a final answer.

6. The method of claim 1, further comprising:
extracting key elements from each of the plurality of short reasoning data items by the large language model; and
incorporating the key elements into both the background and the inquiry corresponding to each short reasoning data item to ensure that the inquiry is linked to the background.

7. The method of claim 1, further comprising:
verifying, by the large language model, whether the background and the inquiry generated from decomposition retains a meaning of a corresponding short reasoning data item.

8. The method of claim 1, wherein the generating a plurality of materials based on the background by the large language model comprises:
generating a plurality of independent and complete passages corresponding to a plurality of key information points of the background.

9. The method of claim 8, further comprising:
verifying, by the large language model, whether the plurality of independent and complete passages and the inquiry retains a same meaning as a corresponding short reasoning data item.

10. The method of claim 1, further comprising:
constructing the long-context background by embedding each of the plurality of materials at a random position within the set of irrelevant materials.

11. A system of enhancing long-context reasoning capabilities of machine learning models, comprising:
at least one processor; and
at least one memory communicatively coupled to the at least one processor and comprising computer-readable instructions that upon execution by the at least one processor cause the at least one processor to perform operations comprising:
prompting a large language model to decompose each of a plurality of short reasoning data items into a background and an inquiry on the background;
generating a plurality of materials by the large language model based on the background, wherein each of the plurality of materials indicates a key information point of the background;
constructing a long-context background by embedding the plurality of materials into a set of irrelevant materials; and
generating a plurality of long reasoning data items by combining the long-context background with the inquiry corresponding to each of the plurality of short reasoning data items.

12. The system of claim 11, the operations further comprising:
training a machine learning model based on the plurality of long reasoning data items and corresponding ground-truth answers, wherein the machine learning model is trained to perform long-context reasoning tasks.

13. The system of claim 12, the operations further comprising:
receiving a long-context question by the machine learning model; and
generating an answer to the long-context question by the machine learning model.

14. The system of claim 11, the operations further comprising:
creating a dataset comprising short questions with diverse patterns from different task categories;
refining the short questions to remove data contamination by the large language model.
prompting the large language model to evaluate a quantity of reasoning steps associated with each of the short questions; and
selecting a subset of the short questions as the plurality of short reasoning data items, wherein each of the subset of short questions satisfies a threshold quantity of reasoning steps to arrive at a final answer.

15. The system of claim 11, the operations further comprising:
extracting key elements from each of the plurality of short reasoning data items by the large language model; and
incorporating the key elements into both the background and the inquiry corresponding to each short reasoning data item to ensure that the inquiry is linked to the background.

16. A non-transitory computer-readable storage medium, storing computer-readable instructions that upon execution by a processor cause the processor to implement operations comprising:
prompting a large language model to decompose each of a plurality of short reasoning data items into a background and an inquiry on the background;
generating a plurality of materials by the large language model based on the background, wherein each of the plurality of materials indicates a key information point of the background;
constructing a long-context background by embedding the plurality of materials into a set of irrelevant materials; and
generating a plurality of long reasoning data items by combining the long-context background with the inquiry corresponding to each of the plurality of short reasoning data items.

17. The non-transitory computer-readable storage medium of claim 16, the operations further comprising:
training a machine learning model based on the plurality of long reasoning data items and corresponding ground-truth answers, wherein the machine learning model is trained to perform long-context reasoning tasks.

18. The non-transitory computer-readable storage medium of claim 17, the operations further comprising:
receiving a long-context question by the machine learning model; and
generating an answer to the long-context question by the machine learning model.

19. The non-transitory computer-readable storage medium of claim 16, the operations further comprising:
creating a dataset comprising short questions with diverse patterns from different task categories;
refining the short questions to remove data contamination by the large language model.
prompting the large language model to evaluate a quantity of reasoning steps associated with each of the short questions; and
selecting a subset of the short questions as the plurality of short reasoning data items, wherein each of the subset of short questions satisfies a threshold quantity of reasoning steps to arrive at a final answer.

20. The non-transitory computer-readable storage medium of claim 16, the operations further comprising:
extracting key elements from each of the plurality of short reasoning data items by the large language model; and
incorporating the key elements into both the background and the inquiry corresponding to each short reasoning data item to ensure that the inquiry is linked to the background.
